(19) United States
(12) Patent Application Publication
(10) Pub. No.: US 2010/0220596 A1
(43) Pub. Date: Sep. 2, 2010

(54) System and method for optimizing the routing of multimedia content

(76) Inventor: Robert B. Hubbard, Marina Del Rey, CA (US)

Correspondence Address: Benman, Brown & Williams, Suite 2740, 2049 Century Park East, Los Angeles, CA, 90067, US

(21) Appl. No.: 12/380,456

(22) Filed: Feb. 27, 2009

(51) Int. Cl. G08C 15/00; H04W 40/00

(52) U.S. Cl. 370/238; 455/445

(57) ABSTRACT

A system for optimizing the routing of data to a subscriber's device. The novel system includes a first sub-system for obtaining records on when each of a plurality of routing methods was available to the device during a predetermined period of time and a second sub-system for recommending a time and routing method to deliver data to the device based on the records. In an illustrative embodiment, the first sub-system includes an applet stored in and executed by the device adapted to monitor what routing methods are available to the device and record what routing methods were available at what times in a data file. The second sub-system includes a neural network artificial intelligence engine adapted to analyze the recorded data to predict when routing methods will be available to the device and identify an optimum time and routing method that minimizes a cost for delivering the data.

### BACKGROUND OF THE INVENTION

1. Field of the Invention

The present invention relates to communications systems. More specifically, the present invention relates to systems and methods for delivering multimedia content to media storage devices.

2. Description of the Related Art

Modern cellular phones are capable of much more than just voice communication. Today's phones can also, for example, exchange text messages and emails, browse the internet, and play multimedia content such as music, video clips, and interactive games.

Multimedia files tend to be much larger than voice packets and can take longer to transmit. It is therefore usually preferable to download or upload multimedia files using an alternate method other than carrier (regular mobile network) in order to reduce costs. For example, files may be transmitted using the internet by connecting the phone to a personal computer via a USB or Bluetooth connection. In addition, an increasing number of phones are equipped with a dual-mode capability that allows them to bypass carrier and use a Wi-Fi connection—for data as well as voice—whenever a Wi-Fi connection is available. In most cases, transmitting files using these alternatives to carrier is essentially free to the user. Wi-Fi and wired internet transmissions are also typically faster than carrier. A user can therefore choose to wait until one of these alternate methods is available to transfer files in order to avoid using airtime minutes and/or incurring additional fees.

In certain applications, however, the content provider instead of the user initiates file transfers and incurs the cost of the transmission. For example, the user may subscribe to a service that periodically sends multimedia content such as advertisements or news or entertainment video clips to his phone. If the user initiates the downloading of the multimedia content, then he can control what method is used to transmit the files. If, however, the content provider initiates the download, there is no way to control what transmission method is used since the content provider does not know when an alternate routing connection such as Wi-Fi will be available to the subscriber's phone. The content provider is therefore forced to send multimedia files via carrier spectrum, which is typically the most expensive routing method.

Hence, a need remains in the art for a system or method for optimizing the routing of multimedia content to cellular phones and other media storage devices.

### SUMMARY OF THE INVENTION

The need in the art is addressed by the system for optimizing the routing of data to a subscriber's device of the present invention. The novel system includes a first sub-system for obtaining records on when each of a plurality of routing methods was available to the device during a predetermined period of time and a second sub-system for recommending a time and routing method to deliver data to the device based on the records. In an illustrative embodiment, the first sub-system includes an applet stored in and executed by the device adapted to monitor what routing methods are available to the device and record what routing methods were available at what times in a data file. The second sub-system includes a neural network artificial intelligence engine adapted to analyze the recorded data to predict when routing methods will be available to the device and identify an optimum time and routing method that minimizes a cost for delivering data.

### BRIEF DESCRIPTION OF THE DRAWINGS

FIG. 1 is a simplified block diagram of a system for delivering multimedia content to media storage devices designed in accordance with an illustrative embodiment of the present invention.

FIG. 2 is a simplified flow diagram of a routing engine designed in accordance with an illustrative embodiment of the present invention.

### DESCRIPTION OF THE INVENTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

The present invention provides a novel system for determining the optimum time and routing method for transmitting multimedia content to a media storage device. In an illustrative embodiment, the novel system is used to optimize the delivery of advertisements (or other types of multimedia content) to specific individuals via their cellular phones. The system may also be adapted for use with other types of media storage devices such as personal digital assistants (PDAs), MP3 players, gaming consoles, satellite radio receivers, digital television receivers, GPS navigation devices, or any other device with a processor, memory, and communication capability. Advertising via cellular phones offers advertisers the ability to target specific individuals, since cellular phones are typically personal devices used primarily by one person. Cellular phones are also more often with the consumer as compared to other advertising mediums such as televisions, and also offer displays and processing power capable of playing high quality multimedia content.

In a preferred embodiment, in order to avoid unsolicited spamming, consumers must opt-in or subscribe to the advertising service to receive ads via their cellular phones. In exchange, the consumers, or “subscribers”, may receive free or discounted products or services such as airtime, phones, music or game downloads, etc. Upon signing up for the service, subscribers are asked to create a subscriber profile that includes general demographic information (such as age, gender, etc.) as well as their personal preferences on the categories of ads they would prefer to receive (such as, for example, entertainment, sports, food, etc.). The advertising system then uses this information to select which advertisements are sent to which subscribers.

In an illustrative embodiment, the downloading of content to the cellular phones is initiated by the advertising service. The content may be downloaded in advance of its scheduled playback time and stored on the phone until being viewed by the subscriber. In accordance with the present teachings, the advertising system includes a novel routing engine that monitors and analyzes a subscriber's behavior patterns in order to predict when the subscriber's phone will be in a preferred spectrum such as Wi-Fi that will minimize data transmission costs.

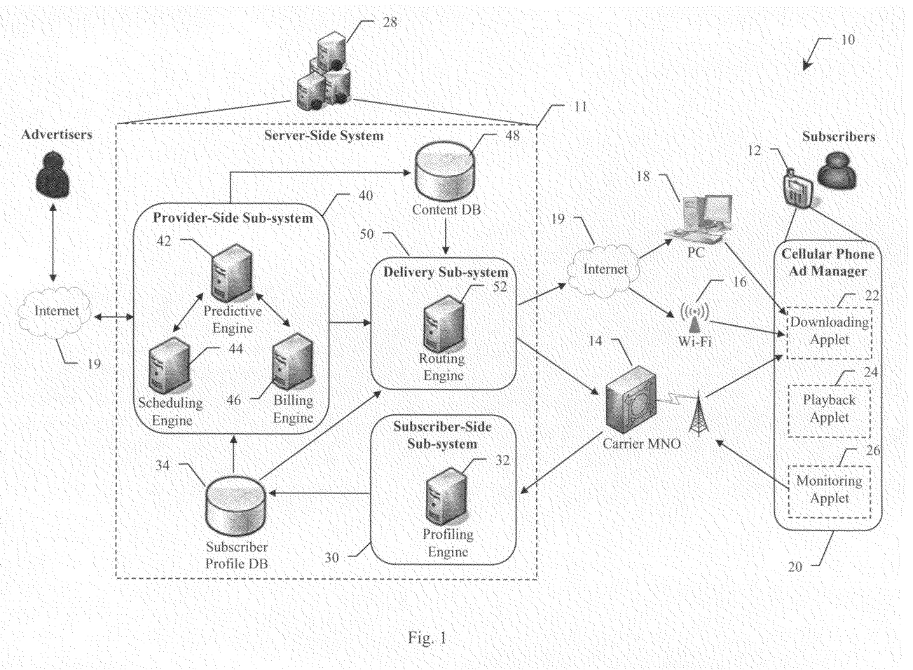

FIG. 1 is a simplified block diagram of a system 10 for delivering multimedia content to media storage devices designed in accordance with an illustrative embodiment of the present invention. In the illustrative embodiment, the system 10 includes a server-side system 11 adapted to deliver advertising content (preferably high quality multimedia ads, similar to television commercials) provided by the advertisers (or other content providers) to subscribers via their cellular phones 12. For simplicity, only one phone 12 is shown in FIG. 1. In a preferred embodiment, the phones 12 are dual-mode phones capable of transmitting data in two or more different spectrums, such as carrier (cellular network) and Wi-Fi and/or satellite, and can automatically detect when a spectrum becomes available. In the illustrative embodiment of FIG. 1, the server-side system 11 and phone 12 can communicate via carrier (through a mobile network operator 14) or a Wi-Fi connection 16, or by connecting the phone 12 to a computer 18 that is connected to the internet 19. Other communications protocols may also be used without departing from the scope of the present teachings.

The advertising service provides each phone 12 with an “ad manager” 20, which is client-side software stored in the phone's internal memory and executed by the phone's processor. The ad manager 20 includes a downloading applet 22 that manages the downloading and storing of ads received from the advertising system 10. In a preferred embodiment, the advertising system 10 embeds a scheduled playback time with each transmitted ad. Ads may be transmitted to the phone 12 at any time prior to the scheduled playback time. The downloading applet 22 stores the ads in the phone's memory until they are viewed by the subscriber. The downloading of ads is preferably invisible to the subscriber and does not interrupt or otherwise affect normal phone usage.

The phone ad manager 22 also includes a playback applet 24 that manages the playback of the ads. At the scheduled playback time, the playback applet 24 indicates on the phone's display that an ad is available for viewing. The subscriber can choose to watch the ad at that time, or save it to watch later. In a preferred embodiment, after an ad is played, the playback applet 24 initiates a procedure for confirming that the subscriber actually watched the ad. For example, the applet 24 may display instructions on the screen to press a particular keypad within a particular amount of time (say, for example, ten seconds). If the subscriber follows the instructions within the allotted time, he is awarded credits for watching the ad. The credits can then be used for purchasing goods or services. This procedure allows the system 10 to confirm to the advertiser not only that the ad was displayed, but also that the subscriber was actually watching it.

The phone ad manager 20 also includes a monitoring applet 26 for monitoring and recording the subscriber's behavior, particularly what spectrums the phone 12 is in, how long the phone remains in each spectrum, and at what times. The monitoring applet 26 may also monitor the subscriber's responses to ads, for example: whether an ad was downloaded successfully, at what time the ad was played, whether the subscriber watched the ad in its entirety (as indicated by his following of the subsequent screen instructions as described above), whether the ad was saved, the user's actions after viewing the ad, etc.

The monitoring applet 26 may also monitor and record other subscriber behavior patterns, such as phone usage, phone location, web browsing, purchases made via the phone, and any other recordable metrics that may be useful to the system 10 for modeling the subscriber's behavior and predicting how he will respond to future ads. The monitoring applet 26 accumulates and saves the subscriber's behavior patterns and responses to ads in a data file and transmits the file to the server-side system 11 periodically (such as once a day). In the illustrative embodiment of FIG. 1, the monitored data files are transmitted from the phone 12 to the server 11 via carrier; however, the data may also be transmitted via Wi-Fi, satellite, USB, or any other communication method without departing from the scope of the present teachings.

In accordance with the present teachings, the advertising system 10 includes a server-side system 11 that uses the data obtained by the monitoring applet 26 to optimize the delivery of ads to the subscribers, by recommending the best subscribers to receive a particular ad, the best time to schedule an ad, the price for delivering the ad, and the best time and routing method to transmit the ads to the phones. In an illustrative embodiment, the server-side system 11 is implemented in software stored in and executed by a bank of servers 28.

The server-side system 11 includes a subscriber-side sub-system 30, a provider-side sub-system 40, and a delivery sub-system 50, plus a subscriber profile database 34 and a content database 48. The subscriber-side sub-system 30 receives the data monitored by the cellular phones 12 and uses the data to update a profile on each subscriber. The subscriber profiles are then stored in the subscriber profile database 34. Each subscriber profile includes information about the subscriber's demographic details and personal preferences, as well as his recorded behavior patterns and responses to ads. The provider-side sub-system 40 uses the subscriber profiles to help the advertisers (the content providers) refine their advertising campaigns, including the selection of which subscribers should be targeted to receive their ads, which are stored in the content database 48. The delivery sub-system 50 then uses the recorded subscriber behavior patterns to determine the optimal time and routing method to transmit the ads to the cellular phones 12 of each selected subscriber.

The subscriber-side sub-system 30 generates and maintains the subscriber profiles stored in the profile database 34. The subscriber-side sub-system 30 sifts through the monitored data received from each phone 12 and saves relevant information to the subscribers' profiles. For example, the subscriber-side system 30 keeps track of what spectrums the phone 12 is in, how long the phone remains in each spectrum, and at what times, as well as other information useful to the system 10 such as the subscriber's responses to ads.

In a preferred embodiment, the subscriber-side sub-system 30 includes a profile refining engine 32 for automatically determining the subscribers' personal preferences based on the subscribers' behavior patterns and responses to ads. In a particular embodiment, the subscriber is asked to specify only a few personal preferences upon registration, and the profiling engine 32 automatically refines the subscriber's preferences to greater detail based on their responses to ads. For example, subscribers may be asked upon registration whether or not they are interested in certain general categories, such as music, movies, sports, food, etc. Over time and continued use of the advertising system, the profiling engine 32 will refine the subscribers' profiles to include more details about their interests. For example, if a subscriber initially indicated that he liked sports, the profiling engine 32 may eventually determine, based on his response to various ads, which sports he likes, which teams he prefers, who his favorites athletes are, etc. The more detailed profiles can help to more accurately predict how the subscriber will respond to future ads. For a description of an illustrative subscriber-side sub-system 30 and profiling engine 32, see co-pending patent application entitled “SYSTEM AND METHOD FOR INTELLIGENTLY MONITORING SUBSCRIBER'S RESPONSE TO MULTIMEDIA CONTENT”, by R. B. Hubbard (Atty. Docket No. Hubbard-2), the teachings of which are incorporated herein by reference.

In operation, advertisers interact with the provider-side sub-system 40 to upload their ads to the content database 48 and specify the parameters of their advertising campaign, including the demographics they want to reach and when they want to schedule their ads for playback. The provider-side sub-system 40 uses the subscriber profiles stored in the subscriber database 34 to provide the advertisers with intelligent information about the specific individual behavior patterns of each subscriber as to their approval/acceptance or disapproval/rejection of particular advertising campaigns, and makes recommendations on an optimal advertising campaign. The advertisers may choose to use the system recommendations or override them and use their own campaign parameters.

In an illustrative embodiment, the provider-side sub-system 40 includes a predictive engine 42 for predicting how subscribers will respond to a particular advertising campaign based on their personal preferences and recorded behavior patterns stored in the profile database 34, and recommending which subscribers should be targeted to receive the ad in order to maximize the predicted subscriber acceptance of the campaign. In particular, the predictive engine 42 identifies the “high uptake” subscribers that are predicted to have a high probability of having a positive response to a particular ad campaign. The predictive engine 42 may also make recommendations on how to modify the campaign parameters in order to improve the predicted acceptance of an ad by “low uptake” subscribers (subscribers predicted to have a low probability of having a positive response to the ad campaign).

For a more detailed description of an illustrative provider-side sub-system 40 and predictive engine 42, see the co-pending patent application entitled “SYSTEM AND METHOD FOR PREDICTING THE OPTIMUM DELIVERY OF MULTIMEDIA CONTENT BASED ON HUMAN BEHAVIOR PATTERNS”, by R. B. Hubbard (Atty. Docket No. Hubbard-1), the teachings of which are incorporated herein by reference.

The provider-side sub-system 40 may also include a scheduling engine 44 for recommending the best time to schedule an ad based on subscriber behavior patterns. In a preferred embodiment, the scheduling engine 44 recommends the best time slot that matches when the subscribers in the targeted demographic prefer to watch their ads, based on their monitored usage patterns (such as at what times the subscriber has previously watched his ads), which are recorded by the monitoring applet 26. An illustrative scheduling engine 44 suitable for this application is described in a co-pending patent application entitled “SYSTEM AND METHOD FOR OPTIMIZING THE SCHEDULING OF MULTIMEDIA CONTENT”, by R. B. Hubbard (Atty. Docket No. Hubbard-4), the teachings of which are incorporated herein by reference.

The provider-side sub-system 40 may also include a billing engine 46 for automatically computing the cost to the advertiser for a particular campaign. In a preferred embodiment, the billing engine 46 sets the price of an ad campaign for an advertiser based on ad type, frequency and volume of ads to be sent, campaign duration, and the acceptance rate of the targeted subscribers. An illustrative billing engine 46 is described in a co-pending patent application entitled “SYSTEM AND METHOD FOR OPTIMIZING THE PRICING OF MULTIMEDIA CONTENT DELIVERY”, by R. B. Hubbard (Atty. Docket No. Hubbard-5), the teachings of which are incorporated herein by reference.

After a campaign is approved by the advertiser, the delivery sub-system 50 transmits the ad to the selected subscribers' cellular phones 12. In accordance with the present teachings, the delivery sub-system 50 includes a novel routing engine 52 that determines the best time and routing method for transmitting an ad to a subscriber's phone 12 based on the subscriber's behavior patterns stored in the subscriber profile database 34.

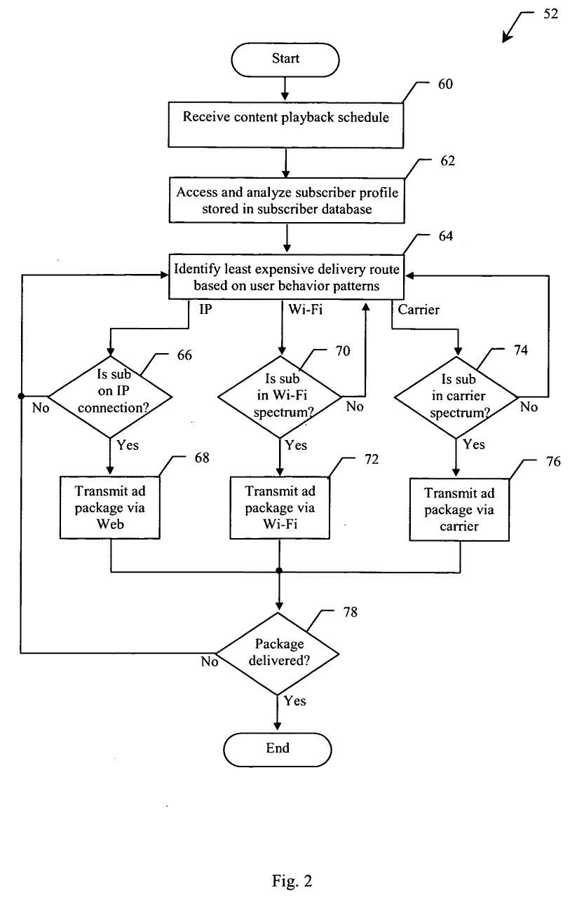

FIG. 2 is a simplified flow diagram of a routing engine 52 designed in accordance with an illustrative embodiment of the present invention.

First, at Step 60, the routing engine 52 receives the scheduled playback time for the ad from the provider-side sub-system 40.

At Step 62, the routing engine 52 accesses and analyzes the data on the subscriber stored in the subscriber profile database 34 and, at Step 64, identifies the optimal time and routing method to deliver the ad based on the subscriber's monitored behavior patterns.

In the illustrative embodiment of FIG. 2, three different routing methods can be used to deliver content to the mobile phone 12: carrier, Wi-Fi, or IP (internet protocol). Carrier spectrum, using the standard cellular network, is usually the most expensive routing method but is almost always available. A Wi-Fi connection, which uses the internet to deliver data, is usually free but is only available while the phone is in a Wi-Fi enabled area, such as a home or office set up with wireless networking, or public hotspots with free Wi-Fi access such as some college campuses, hotels, airports, restaurants, etc. Data may also be transmitted when the phone 12 is connected to a computer (via Bluetooth or USB, for example) with access to the internet. While connected to a computer, the handset 12 is another IP device that the routing engine 52 can pass data to quickly and at no cost. This routing method is the least likely to be available since most subscribers do not regularly connect their mobile phones to a computer. Some subscribers, however, may regularly connect their phones to a computer in order to charge the battery, or to download music, ringtones, wallpaper, etc.

As discussed above, the monitoring applet 26 residing on the phone 12 monitors what spectrums the phone 12 is in, how long the phone remains in each spectrum, and at what times. The subscriber profile therefore includes a log of what spectrums were available to the phone 12 throughout each day.

In accordance with the present teachings, the routing engine 52 analyzes the spectrum logs over a predetermined period of time (for example, two weeks), searching for regular patterns that can be used to predict when the phone 12 will be in a particular spectrum in the future. For example, the log may show that the phone is usually in a Wi-Fi enabled area Mondays through Fridays from 9:30 am to 12:00 pm, and from 2:00 pm until 4:30 pm, or that the phone is usually plugged into a computer with internet access every night from 11:00 pm until 6:00 am.

The routing engine 52 then identifies the best time and routing method to send the data package in order to minimize costs. In the illustrative example, transmitting via Wi-Fi or IP is free and therefore preferred. The routing engine 52 first searches for a time or times (before the ad's scheduled playback time) when the subscriber is predicted to be in a preferred spectrum for a period of time long enough to transmit the data package. If the subscriber is not predicted to be in a preferred spectrum prior to the scheduled playback time, then the data will be transmitted via carrier.

If the routing engine 52 determines that the data must be transmitted by carrier, then the routing engine 52 will also identify the best time to transmit in order to minimize costs. Many mobile service provides offer discounted rates at off-peak hours, such as after 9 pm and/or on weekends. The routing engine 52 will therefore identify the least expensive time prior to the scheduled playback time to deliver the ad.

Data transmission costs may also be affected by how long it takes to complete the transmission. Optionally, the routing engine 52 may also analyze carrier network bandwidth congestion patterns (provided by the mobile network operator) to estimate the time it would take to transmit data to the phone 12. The estimated transmission time can be used to estimate the cost to transmit the data over carrier at various times. The routing engine 52 then selects the best time that minimizes the total cost.

If multiple ads are waiting for delivery to the subscriber, the routing engine 52 may transmit some or all of them at one time. The longer a device 12 remains in a non-carrier spectrum, the more data the routing engine 52 will send in a single burst.

Returning to FIG. 2, at Step 64, the routing engine 52 identifies the best time and routing method for delivering the ad package.

If the routing engine 52 selected an IP connection, then at Step 66, at the specified time, the routing engine 52 attempts to establish an internet connection with the phone 12. If a connection is established, then at Step 68, the ad package is transmitted to the phone 12 via the internet. If, however, the phone is not connected to the internet as predicted and the routing engine cannot establish connection, then the routing engine 52 returns to Step 64 and searches for the next best time and method to deliver the ad. If the subscriber is predicted to remain in that spectrum for a long time (several hours), the routing engine 52 may make multiple attempts throughout that period to establish a connection the phone 12.

Similarly, if the routing engine 52 selected a Wi-Fi connection, then at Step 70, at the specified time, the routing engine 52 attempts to establish a Wi-Fi connection with the phone 12. If a connection is established, then at Step 72, the ad package is transmitted to the phone 12 via Wi-Fi. If, however, the phone is not in a Wi-Fi spectrum as predicted and the routing engine cannot establish connection, then the routing engine 52 returns to Step 64 and searches for the next best time and method to deliver the ad.

If the routing engine 52 selected carrier, then at Step 74, at the specified time, the routing engine 52 attempts to establish a carrier connection with the phone 12. If a connection is established, then at Step 76, the ad package is transmitted to the phone 12 via carrier. If the routing engine cannot establish connection, then the routing engine 52 returns to Step 64 and searches for the next best time to deliver the ad.

Finally, at Step 78, the routing engine 52 checks if the data package was transmitted successfully. If not, the routing engine 52 returns to Step 64 and tries again.

In a preferred embodiment, the subscriber-side sub-system 30 continuously monitors the subscriber's behavior and updates the subscriber's profile. If a subscriber's behavior patterns change, this will be reflected in the subscriber's profile and the routing engine 52 will adapt accordingly. For example, the routing engine 52 will send ads via Wi-Fi to a student who is frequently and regularly on a college campus with Wi-Fi access during the school year. When the student goes home for the summer, his spectrum patterns will change and the routing engine 52 will adapt. If during the summer, the student is rarely in a Wi-Fi spectrum, the routing engine 52 will stop trying to send data via Wi-Fi and will switch to sending ads via carrier at off-peak hours, when possible. When the student returns to campus, the routing engine 52 has to re-adapt and again, choose Wi-Fi or the most cost effective spectrum to send data to the device.

In a preferred embodiment, the routing engine 52 includes a neural network artificial intelligence (AI) engine comprised of a plurality of interconnected neural nodes adapted to automatically identify the optimum time and routing method for delivering data as described above. The first step to developing a neural node is to identify what adaptive functions the node is expected to perform. This is accomplished by creating a “rule set” to test the conditions of the business process. A rule set is essentially code that can be extracted into any preferred language, such as C++ or C#, as a set of hard-coded programmatic instructions with the ability to adjust its behavior related to changes in the environment in which it is monitoring. Once the rule set is determined and tested to meet all conditions, a stable engine then exists. It is at this point that the adaptive neural node can be created.

The routing engine 52 has to perform these tasks for potentially millions of subscribers on a minute-by-minute basis, everyday and adapt to each individual device and usage of the devices. This is a high performance, highly adaptive task that needs an adaptable engine that has hard-coded “base” rules to work from, and then change as needed on its own to maintain the desired goal: send data via the most cost effective path possible.

Thus, the present invention has been described herein with reference to a particular embodiment for a particular application. Those having ordinary skill in the art and access to the present teachings will recognize additional modifications, applications and embodiments within the scope thereof. For example, while the invention has been described with reference to an application for delivering advertisements to cellular phones, the present teachings may also used for delivering other types of data or for delivering to other types of media storage devices.

It is therefore intended by the appended claims to cover any and all such applications, modifications and embodiments within the scope of the present invention.

Accordingly,

What is claimed is:

1. A system for optimizing the routing of data to a subscriber's device comprising:
first means for obtaining records on when each of a plurality of routing methods was available to said device during a predetermined period of time and
second means for recommending a time and routing method to deliver said data to said device based on said records.

2. The invention of claim 1 wherein said second means includes means for analyzing said records to predict times when said routing methods will be available to said device.

3. The invention of claim 2 wherein said second means includes means for searching for patterns in said records.

4. The invention of claim 2 wherein said second means includes means for identifying an optimum time and routing method from said predicted times and routing methods that minimizes a cost for delivering said data.

5. The invention of claim 4 wherein said data includes multimedia content having a scheduled playback time.

6. The invention of claim 5 wherein said routing methods include carrier and an alternative to carrier.

7. The invention of claim 6 wherein said second means is adapted to select said alternative routing method if said alternative method is predicted to be available to said device for a time period sufficient to transmit said data prior to said scheduled playback time.

8. The invention of claim 7 wherein said second means is adapted to select carrier if said alternative method is not predicted to be available.

9. The invention of claim 6 wherein said alternative routing method includes Wi-Fi and/or internet protocol.

10. The invention of claim 1 wherein said second means includes a neural network artificial intelligence engine.

11. The invention of claim 1 wherein said first means includes an applet stored in and executed by said device adapted to monitor what routing methods are available to said device and record what routing methods were available at what times in a data file.

12. The invention of claim 7 wherein said first means further includes a subscriber-side sub-system adapted to receive said recorded data from said applet and save said recorded data in a database.

13. The invention of claim 2 wherein said multimedia content includes an advertisement.

14. The invention of claim 1 wherein said device is a cellular phone.

15. A system for optimizing the routing of multimedia content to a media storage device comprising:
an applet stored in and executed by said media storage device adapted to monitor what routing methods are available to said media storage device and record what routing methods were available at what times in a data file;
a first sub-system adapted to receive said recorded data from said applet; and
a second sub-system for recommending a time and routing method to deliver said content to said media storage device based on said recorded data.

16. A system for delivering multimedia content to media storage devices comprising:
a database for storing profiles on a plurality of media storage devices;
an applet stored in and executed by each of said media storage devices adapted to monitor what routing methods are available to said device and record what routing methods were available at what times in a data file;
a subscriber-side sub-system for receiving said recorded data from said applets and updating said profiles accordingly;
a provider-side sub-system for selecting media storage devices to receive multimedia content;
a scheduling engine for selecting a playback time for said content;
a routing engine for determining an optimum delivery time and optimum routing method to deliver said content for each selected media storage device based on said recorded data; and
a delivery sub-system for delivering said content to each selected media storage device using said optimum routing method at said optimum delivery time.

17. A method for optimizing the routing of data to a subscriber's device including the steps of:
obtaining records on when each of a plurality of routing methods was available to said device during a predetermined period of time and
recommending a time and routing method to deliver said data to said device based on said records.
